(19) United States
(12) Patent Application Publication
(10) Pub. No.: US 2019/0236539 A1
(43) Pub. Date: Aug. 1, 2019

(54) SYSTEM AND METHOD FOR DELIVERY VEHICLE SECURITY USING BLOCKCHAIN

(71) Applicant: Walmart Apollo, LLC, Bentonville, AR (US)

(72) Inventors: Brian MCHALE, Oldham (GB); Jennifer NORTHRUP, Eureka Springs, AR (US); Richard C. MCSORLEY, Bentonville, AR (US); Steven LEWIS, Bentonville, AR (US); Christopher R. HEENEY, Bella Vista, AR (US); Joseph JURICH, Molino, FL (US)

(73) Assignee: Walmart Apollo, LLC, Bentonville, AR (US)

(21) Appl. No.: 16/262,541

(22) Filed: Jan. 30, 2019

Related U.S. Application Data
(60) Provisional application No. 62/624,737, filed on Jan. 31, 2018.

(51) Int. Cl. G06Q 10/08; G07C 9/00; B60R 25/10; B60R 25/33

(52) U.S. Cl. CPC G06Q 10/0833; G07C 9/00309; G07C 9/00817; G06Q 10/0838; H04L 9/0643; B60R 25/10; B60R 25/33; G07C 2009/0042; G07C 2009/0092; G07C 9/00896

(57) ABSTRACT

A system for order delivery security using blockchain includes a container configured to: add a new block to a blockchain when an item of a customer order is added to or removed from the container, wherein the new block contains an order ID of the customer order, a customer name, items in the customer order, a delivery address of the customer order, and a delivery date of the customer order; a delivery vehicle configured to: carry the container; and add a new block to the blockchain when an item of the customer order is added to or removed from the vehicle, wherein the new block contains the order ID of the customer order, the customer name, the items in the customer order, the delivery address of the customer order, and the delivery date of the customer order; and a lock configured to: be attached to and secure the container; store a copy of the blockchain locally in memory of the lock; and communicate with the delivery vehicle. The vehicle carrying the container is further configured to communicate with the lock to determine that the container has been loaded, unloaded or is still on the vehicle.

### BACKGROUND

### 1. Technical Field

The present disclosure relates to blockchain technology, and more specifically to a system and method for delivery vehicle security using blockchain.

### 2. Introduction

As the Internet of Things (IoT) continues to evolve, communications between devices continue to evolve. For example, autonomous cars are being designed to use mesh networks for communications between cars, such that every car is aware of speed, direction, braking, etc., of the other cars. An unmanned aerial vehicles (UAVs) are being similarly designed, allowing unprecedented coordination between them. Similarly, devices within a system of customer order delivery can be designed to communicate with each other for improving delivery security.

However, while the currently available communications between devices or vehicles allow for more informed devices, they do not necessarily improve other aspects of the devices. For example, having more informed devices does not, by itself, provide for collaborative computing, collaboratively storing data in databases, collaboratively sharing battery power, and collaboratively sharing digital currency between those informed devices.

### SUMMARY

A system for order delivery security using blockchain includes a container configured to: add a new block to a blockchain when an item of a customer order is added to or removed from the container, wherein the new block contains an order ID of the customer order, a customer name, items in the customer order, a delivery address of the customer order, and a delivery date of the customer order; a delivery vehicle configured to: carry the container; and add a new block to the blockchain when an item of the customer order is added to or removed from the vehicle, wherein the new block contains the order ID of the customer order, the customer name, the items in the customer order, the delivery address of the customer order, and the delivery date of the customer order; and a lock configured to: be attached to and secure the container; store a copy of the blockchain locally in memory of the lock; and communicate with the delivery vehicle. The vehicle carrying the container is further configured to communicate with the lock to determine that the container has been loaded, unloaded or is still on the vehicle.

A method includes: assigning a customer order to a tote and a smart lock; recording an order ID of the customer order and item information as each item of the customer order is scanned into the tote, wherein the item information includes a name of the item, a quantity of the item, a delivering date of the item, and a delivery address of the item; recording a video as each item of the customer order is scanned into the tote; communicating information of the order ID, the item, and the video to the smart lock; closing and locking with the smart lock the tote when the tote is full or the order is fulfilled; interrogating each tote to ensure that all of the totes for the customer order are loaded onto a delivery vehicle when the tote is loaded into the delivery vehicle; directing the driver which totes should be removed at each delivery point; and providing a key to the driver to unlock the smart lock.

A non-transitory computer-readable storage medium configured as disclosed herein can have instructions stored which, when executed by a computing device, cause the computing device to perform operations which include: assigning a customer order to a tote and a smart lock; recording an order ID of the customer order and item information as each item of the customer order is scanned into the tote, wherein the item information includes a name of the item, a quantity of the item, a delivering date of the item, and a delivery address of the item; recording a video as each item of the customer order is scanned into the tote; communicating information of the order ID, the item, and the video to the smart lock; closing and locking with the smart lock the tote when the tote is full or the order is fulfilled; interrogating each tote to ensure that all of the totes for the customer order are loaded onto a delivery vehicle when the tote is loaded into the delivery vehicle; directing the driver which totes should be removed at each delivery point; and providing a key to the driver to unlock the smart lock.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 illustrates an exemplary peer-to-peer network between delivery vehicles and devices;

FIG. 2 illustrates an exemplary blockchain based on interactions between devices;

FIG. 3 illustrates an exemplary method of securing order delivery; and

FIG. 4 illustrates an exemplary computer system.

### DETAILED DESCRIPTION

Various specific embodiments of the disclosure are described in detail below. While specific implementations are described, it should be understood that this is done for illustration purposes only. Other components and configurations may be used without parting from the spirit and scope of the disclosure, and can be implemented in combinations of the variations provided. These variations shall be described herein as the various embodiments are set forth.

In this disclosure, a system for providing security for a delivery vehicle using blockchain is described. The system may add a new block to a blockchain when an item is added to or removed from a container, and a delivery vehicle configured to add a new block to the blockchain when an item is added to or removed from the vehicle. The system may also include a scanning device configured to: record an item entering or leaving the container; and transfer the recorded information of the item to the container. The system may further include a lock configured to: secure the container; store a copy of the blockchain locally; and be associated with the container when the lock and the container are scanned by the scanning device. Such a lock may referred to as a smart lock. The vehicle carrying the container may be further configured to communicate with the lock to determine that the container has been loaded onto the vehicle, unloaded from the vehicle, or is still on the vehicle.

In an example scenario, a customer may place an order, for example, from an online store. The order may include one or more items. The online store may collect the items and prepare the order for delivery. Information about the order and items can be stored in a block of a blockchain. The information may include customer name, financial information, order number, order date and time, items description, and expected delivery date and time. The order may be loaded into one or more containers or totes. The containers may each be assigned and associated with a corresponding smart lock. When one or more items of the order is loaded into a container, information about the order and items, load date and time, persons who assemble the order, etc. may be collected and communicated to the smart lock. For example, a scanner or RFID reader can scan the items being loaded and transfer the information to the smart lock. The information of loading the order may be hashed into a block of the blockchain, such that the order may be assured to be complete, authenticated, and verified.

Once the order is complete, the container may be locked with the smart lock and loaded onto a delivery vehicle. Information of loading the containers to the vehicle may be hashed into a block of the blockchain. Such information may include the order information, the container information, and the vehicle information. By using blockchain to track the order, access to information can be decentralized that is authentic and whose “chain of title” is irrefutable. The blockchain is tamper-evident. No parties can tamper with a transaction after the transaction has been recorded to the blockchain. If a transaction is changed, a new transaction must be used to reverse the change, and both transactions are then visible. A single and shared blockchain can provide one place to go to determine the ownership and status of the order without disputes. In such a way, the order may be secured to deliver. The vehicle may be a person-operated vehicle or an autonomous vehicle (e.g., a drone).

When the order arrives at a delivery point, the container containing the order may be unloaded from the vehicle, and the lock may be unlocked. Items are removed from the container for delivery. Information of the items removed from the container may be recorded and hashed into a block of the blockchain. The order can be retrieved to be delivered securely and completely. For example, whenever an item is removed from the container, the smart lock may update the item information and hash it into the block of the blockchain.

In a case where one item of an order may be forgotten or missing from the delivery, an alert message may be sent out. For example, the delivery vehicle may examine the blockchain to compare the blocks in which information regarding removed items is recorded with the blocks in which information regarding the items of the order being loaded into the container. If an inconsistency is identified, the alert message may be sent, for example, to a vehicle controller or to the vehicle driver. Such alert message may be hashed into a block of the blockchain.

The blockchain can give a level of confidence that a customer order is the correct order. This disclosed system can be used to ensure that a container has not been opened prior to the order being received by a customer.

In some embodiments, a blockchain enabled seal may be placed on a tote, a container, a drone bay, an automated guided vehicle (AGV) hold or truck door to securing the order therein. The system may add a new block to the blockchain each time an item is added or removed from the truck, container, etc.

In some embodiments, the system may include a scanning device, such as a scanner or a radio frequency identifier (RFID) reader which is configured to record products entering or leaving the blockchain enabled container.

In some embodiments, the system may further include a smart loading device such as a smart fork lift that may transfer items of the order to the container. Further, the smart fork lift may be equipped with a scanner or a RFID reader that may scan the items and communicate data of the items to the smart lock of the container.

The system can ensure that the items in the container are what was ordered. The system may log the data of an item into a blockchain as a store associate picks the item to fulfill an order and scans the item. The system can capture the data associated with the item, the store associate and the order, and then add such information to the blockchain ledger for the order.

In some embodiments, the smart lock may be a blockchain enabled physical lock. The lock may be used to secure the container. The lock may have a small solar panel attached to maintain battery charge of the lock. The lock may also store a copy of the blockchain records locally in memory. As the store associates place items into the container, the items may be scanned and the scanning information may be added to the lock associated with the container. The lock may be associated with the container via an ID of the lock and an ID of the container, for example, the items are assigned to the ID of the lock and the ID of the container. When the items are being loaded into the container, the associated lock for the container may or may not be physically affixed to the container yet. This can add the scanned items to the container and add data of the scanned item to the blockchain record for the container and the order.

In some embodiments, the lock may communicate using WIFI or Bluetooth. The delivery vehicle carrying the container may communicate with the locks contained in the cargo bay of the vehicle to determine that the correct containers have been loaded, unloaded or are still on the vehicle. The system may also send an alert to the driver of the vehicle if a container listed on a manifest has not been loaded. For example, the system may examine the blockchain to compare the blocks in which information regarding the manifest is recorded with the blocks in which information regarding the containers loaded onto the vehicle. If an inconsistency is identified, the alert message may be generated and sent out.

In some embodiments, the system may provide the store associate a code to open a lock when required. The system may record each time the lock is opened and whenever an item is added to or removed from the container. The system may also record where the lock is at each transaction. A CCTV camera feed from a facility (e.g., a store kiosk) where the container is being loaded may be tapped to record the video of the loading of the container. Alternatively, a mobile device that the store associate uses for order fulfilling can record a video of the transfer of items. Similarly, when the container is delivered to a customer, the deliverer's mobile device (or the drone's camera) can record the container, lock, container contents and the customer receiving the order. Such recording may be hashed into one or more blocks of the blockchain.

Systems, methods, and computer-readable storage media configured according to this disclosure are capable of securing order delivery. The system may comprise a container, a scanner for scanning items of the order to collect information of the order, a lock to secure the container, and a vehicle for delivering the order. As used herein, the container, the scanner, the lock, and the vehicle may be referred to as devices. As a device determines that it needs additional information (e.g., delivery location, order number, customer name, etc.), it sends a request to other devices requesting that those other devices send the device the information needed. This distribution request can, for example, be broadcast through a mesh network between devices, until all the devices within a group, or within a radius of the initial requesting device, have received the request. As devices receive the request, responses to the request are generated and sent back to the requesting device, each response providing an answer as to the ability of each respective device to fulfill the request. The requesting device receives the responses, aggregates and analyzes the responses, and determines how to transition information and resources to a new computing configuration, where the information can be shared, based on the responses. In some cases, this can require transferring information from the requesting device to another device through the mesh network. In addition, this can require modifying computing capacities or configurations at the requesting device as well as other devices within the group of devices. These changes would be broadcast to the group through the mesh network, with any computing resource transitions likewise similarly being broadcast to the group.

Each of these devices may be capable of being remotely controlled and configured by a user through a WiFi connection each device has with a WiFi network. In addition, the devices within this group can communicate with one another. In some configurations, such communications can utilize a mesh network (i.e., each device communicates with the other devices directly using RF, low power, Bluetooth, or other wireless short range communication mechanisms, or if direct communication is not possible due to power or range restriction, indirectly through communication relays provided by another device in the group), whereas in other configurations the communications occur directly though the WiFi network.

In some configurations, communications between the devices can take the form of a blockchain, where each request and response made by devices can be added to the blockchain ledger. As any device takes an action (sending a request, sending a response to a request), that information is added to the blockchain. More specifically, the request, response, or other action is hashed into the previous blockchain. This new, updated blockchain is then distributed to the other devices within the group.

In other circumstances, the devices may be unmanned or autonomous vehicles, drones, robotics, communication devices, or any other electronic device. For example, in one configuration the devices communicating availability may be delivery drones, whereas in another configuration the devices may be autonomous vehicles or smart home devices. In yet another configuration, the devices may be distinct types of devices, such as a drone and smart home devices communicating, making requests, and generating responses to those requests.

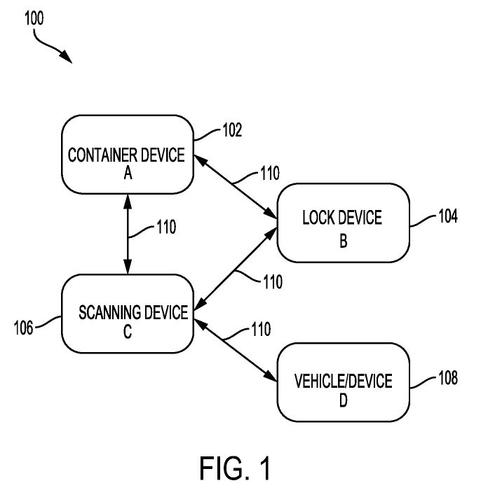

FIG. 1 illustrates an exemplary mesh network 100 between delivery vehicles and devices 101, 104, 106, 108. A mesh network such as that illustrated is a network where each node can relay data from and to other nodes within the network. While mesh networks can be constructed to operate in wired conditions, they are more prevalent in wireless configurations, where messages can be broadcast to other nearby nodes (i.e., not sent to a specific node, but rather all nodes within a given distance of the broadcasting node). When a receiving node is located outside the broadcast range of a transmitting node, intermediate nodes may be required to route the transmission to the receiving node. For example, as illustrated, node A 101 can communicate 110 with nodes B 104 and C 106, and nodes B 104 and C 106 can communicate 110 with each other. However, nodes A 101 and B 104 cannot communicate with node D 108. Because node D 108 can only communicate with node C 106, any communications 110 between node A 101 and node D 108, or between node B 104 and node D 108, must route through node C 106.

When requesting and distributing order information, delivery information, and security information, the various exemplary devices illustrated in FIG. 1 and discussed above may communicate with one another via the mesh network 100. That is, the devices can transmit, receive, and relay messages between themselves as necessary.

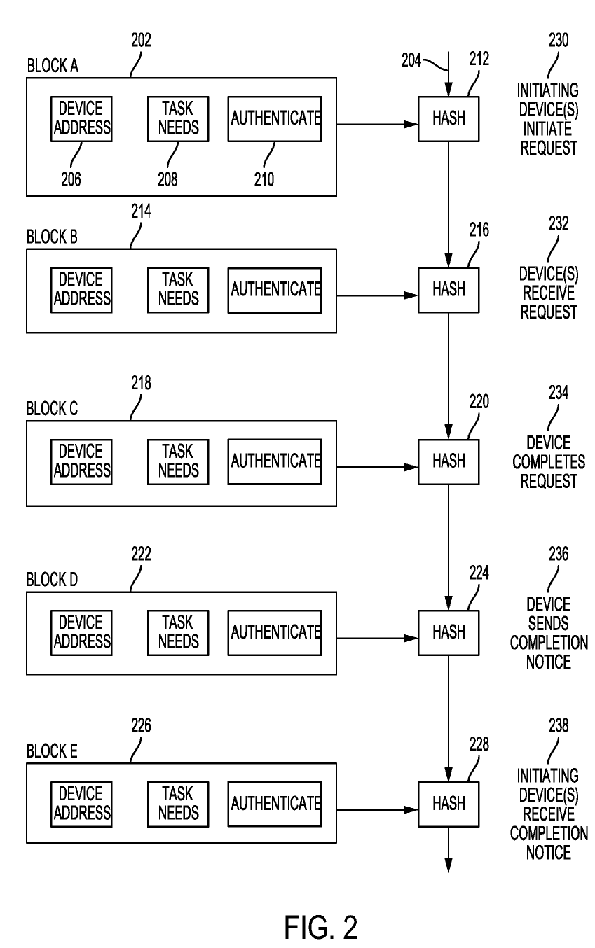

FIG. 2 illustrates an exemplary blockchain based on interactions between devices. A blockchain is a distributed digital ledger which is communicated electronically between devices. Each transaction recorded within the digital ledger is a block which can be hashed or otherwise encrypted. As new transactions are added to the digital ledger, each transaction's veracity can be tested against the previous ledger stored by the devices, and can, in some configurations, require confirmation from a defined percentage (usually 50%) of the devices to be added to the blockchain.

In the case of securing order delivery, and communicating order information tasks among the various devices based on the responses to the requests, the blockchain can take the form illustrated in FIG. 2. In this example, there is a blockchain 204 which has been distributed among multiple devices. One of the devices, an initiating device (e.g., the container 102), determines that distributing order information among other devices would be a better outcome, and proceeds to initiate a request 230. Initiation of the request, in this example, includes generating a block (Block A 202). In this example, each block added to the blockchain contains the device address 206 or identification of the device making the request, responding to the request, or otherwise communicating with the remaining devices in the group of devices. The blocks can contain the task needs 208, which can include the specific request for order information or actions, responses to requests, completion notifications, etc. In addition, the blocks can contain an authentication 210 portion, where the device can approve or authenticate the validity of other transactions and provide authority for the present transaction.

As the device generates the block 202 for the initial request, the block 202 is hashed 212 into the previous blockchain 204, resulting in an updated blockchain which is distributed among the devices in the group. The other devices receive the updated blockchain containing the request 232 and generate a block 214 in response to the request. These responses are hashed 216 into the blockchain. In some scenarios, an additional block could be generated by the initiating device based on the response block 214, indicating what action will be taken based on the responses received. For example, an alert may be sent out when one item of the order is not delivered.

When a device completes the request 234, that device generates a block 218 which is subsequently hashed 220 and added to the blockchain. If a completion notice 236 needs to be generated and sent to the initiating device, the completing device can generate another block 222, which can similarly be hashed 224 and added to the blockchain. Once the initiating device receives the completion notice 238, it may generate a notification indicating the request has been fulfilled, which would similarly require a block 226 to be generated and hashed 228 into the blockchain.

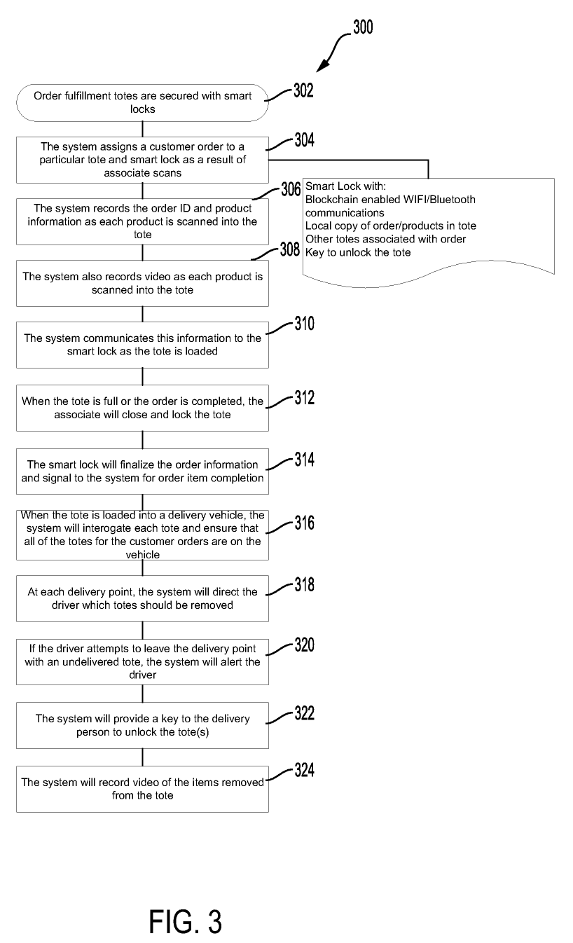

FIG. 3 illustrates a flow chart of an exemplary method 300 of securing order delivery. The method 300 may be implemented in the system 100 of FIG. 1 and the blockchain of FIG. 2, and may comprise the following steps.

At step 302, order fulfillment totes are secured with smart locks. The totes herein can be container devices to contain items of customer orders. Each tote is equipped with a smart lock to secure the tote.

At step 304, a customer order is assigned to a particular tote and smart lock. For example, the order number of the customer order may be associated with a tote ID of the tote and a lock ID of the smart lock. Such association between the customer order, the particular tote, and the smart lock may be hashed into a block of the blockchain. As items are scanned, they are added to the order. Herein a smart lock may be configured to have blockchain enabled WIFI/Bluetooth communications, a local copy of order and products in the particular tote, information of other totes associated with the order, and a key to unlock the tote. The store associate may use a scanner or a RFIP reader to scan items of the customer order. The scanned items may be placed into the particular tote. The items of the customer order may also be placed into different totes. The smart locks associated with corresponding totes may communicate with each other to ensure the integrity of the customer order.

At step 306, the order ID and item information are recorded as each item is scanned into the particular tote. Such scanned information may be hashed into one or more blocks of a blockchain. The smart lock of the particular tote may store a copy of the blockchain locally in memory. As described above, the order number of the customer order may be associated with the tote ID of the tote and the lock ID of the smart lock.

At step 308, a video may be recorded as each product is scanned into the tote. The video may be recorded using a mobile phone, for example, by the store associate. The video may also be recorded using a video camera from a delivery vehicle into which the tote is loaded for delivery. The video may also be recorded using a video camera attached to the tote. The video may also be recorded using video camera in the store. The video may be hashed into a block of the blockchain.

At step 310, the information of order ID, items of the order, and the video may be communicated to the smart lock as the tote is filled and loaded unto the delivery vehicle.

At step 312, the tote is closed and locked, for example, by the store associate, when the tote is full or the order is completed. The tote is locked with the smart lock. The tote may be further applied a seal to ensure the security of the order items.

At step 314, the smart lock may finalize the order information and signal to the system for order item completion. For example, the smart lock may refer to blocks of the blockchain in which the order is recorded when the order was placed, and blocks of the blockchain in which the order information is recorded when the order is scanned and loaded into the tote. The smart lock may compare those blocks and ensure the correctness and completeness of the order. Such actions may be referred to as “finalizing the order information.” Once the order information is finalized in the smart lock, the smart lock may communicate to the delivery vehicle and other devices of the system to indicate that the order is completed.

At step 316, each tote may be interrogated to ensure that all of the totes for the customer orders are on the delivery vehicle, when the tote is loaded into the delivery vehicle. The “interrogation” may refer to the following example. For example, the copies of the blockchain stored in the smart locks associated with corresponding totes may be compared one another, as well as to the copy of the blockchain stored in the delivery vehicle, to ensure the integrity of the orders.

At step 318, at each delivery point, the driver may be directed which totes should be removed from the delivery vehicle. When arriving at a delivery location, the system may determine which tote should be opened and removed from the delivery vehicle, and which items should be removed from the opened tote. Such determination and information may be hashed into a block of the blockchain. In some embodiments, an unmanned vehicle may be instructed to drop one or more totes of the order at the delivery point.

At step 320, the driver may be alerted if the driver attempts to leave the delivery point with an undelivered tote. After the totes are removed from the delivery vehicle, the information regarding the totes is further updated to reflect such removal. The information regarding the totes can be retrieved from the blockchain and checked. For example, the information regarding the totes may include the IDs of the totes, which totes contain the order, how many totes were loaded into the vehicle, which tote should be delivered at each delivery point, etc. If a tote to be removed was not removed, the information regarding this tote may not be further updated, such that the system may send out a notification to the driver to indicate that this tote should be removed. All those actions and information may further be hashed into blocks of the blockchain.

At step 322, a key may be provided to the delivery person to unlock the tote(s). After the totes are removed from the delivery vehicle, a key associated with each of the totes may be provided by the system to unlock the totes. The key as used herein may a physical key to unlock the smart lock of the tote, or a password used for unlocking the smart lock of the tote. In some embodiments in which a drone is used for delivering the totes, the tote may be unlocked remotely by the drone, for example via triggering by a signal from the drone to an actuator of the smart lock. The tote door may then automatically open to dispense items of the order. Such information and action may be hashed into a block of the blockchain.

At step 324, a video of the items removed from the tote may be recorded. The video may be recorded using a mobile phone, for example, by the driver. The video may also be recorded using a video camera from the delivery vehicle. The video may be hashed into a block of the blockchain. Further the driver may use a scanner or a RFID reader to scan the removed items to reflect such removal and to communicate such scanned information to the smart lock or the delivery vehicle. As such, the customer orders can be ensured to be delivered correctly and completely.

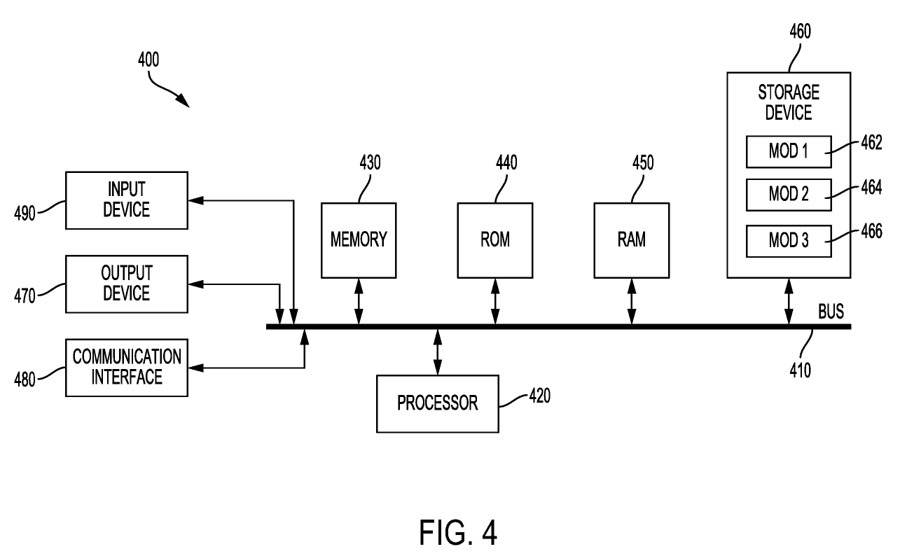

With reference to FIG. 4, an exemplary system 400 can include a processing unit (CPU or processor) 420 and a system bus 410 that couples various system components including the system memory 430 such as read only memory (ROM) 440 and random access memory (RAM) 450 to the processor 420. The system 400 can include a cache of high speed memory connected directly with, in close proximity to, or integrated as part of the processor 420. The system 400 copies data from the memory 430 and/or the storage device 460 to the cache for quick access by the processor 420. In this way, the cache provides a performance boost that avoids processor 420 delays while waiting for data. These and other modules can control or be configured to control the processor 420 to perform various actions. Other system memory 430 may be available for use as well. The memory 430 can include multiple different types of memory with different performance characteristics. It can be appreciated that the disclosure may operate on a computing device 400 with more than one processor 420 or on a group or cluster of computing devices networked together to provide greater processing capability. The processor 420 can include any general purpose processor and a hardware module or software module, such as module 1 462, module 2 464, and module 3 466 stored in storage device 460, configured to control the processor 420 as well as a special-purpose processor where software instructions are incorporated into the actual processor design. The processor 420 may essentially be a completely self-contained computing system, containing multiple cores or processors, a bus, memory controller, cache, etc. A multi-core processor may be symmetric or asymmetric.

The system bus 410 may be any of several types of bus structures including a memory bus or memory controller, a peripheral bus, and a local bus using any of a variety of bus architectures. A basic input/output (BIOS) stored in ROM 440 or the like, may provide the basic routine that helps to transfer information between elements within the computing device 400, such as during start-up. The computing device 400 further includes storage devices 460 such as a hard disk drive, a magnetic disk drive, an optical disk drive, tape drive or the like. The storage device 460 can include software modules 462, 464, 466 for controlling the processor 420. Other hardware or software modules are contemplated. The storage device 460 is connected to the system bus 410 by a drive interface. The drives and the associated computer-readable storage media provide nonvolatile storage of computer-readable instructions, data structures, program modules and other data for the computing device 400. In one aspect, a hardware module that performs a particular function includes the software component stored in a tangible computer-readable storage medium in connection with the necessary hardware components, such as the processor 420, bus 410, display 440, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 400 is a small, handheld computing device, a desktop computer, or a computer server.

Although the exemplary embodiment described herein employs the hard disk 460, other types of computer-readable media which can store data that are accessible by a computer, such as magnetic cassettes, flash memory cards, digital versatile disks, cartridges, random access memories (RAMs) 450, and read only memory (ROM) 440, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 400, an input device 490 represents any number of input mechanisms, such as a microphone for speech, a touch-sensitive screen for gesture or graphical input, keyboard, mouse, motion input, speech and so forth. An output device 440 can also be one or more of a number of output mechanisms known to those of skill in the art. In some instances, multimodal systems enable a user to provide multiple types of input to communicate with the computing device 400. The communications interface 480 generally governs and manages the user input and system output. There is no restriction on operating on any particular hardware arrangement and therefore the basic features here may easily be substituted for improved hardware or firmware arrangements as they are developed.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A system for order delivery security using blockchain, comprising:
a container configured to:
add a new block to a blockchain when an item of a customer order is added to or removed from the container, wherein the new block contains an order ID of the customer order, a customer name, items in the customer order, a delivery address of the customer order, and a delivery date of the customer order;
a delivery vehicle configured to:
carry the container; and
add a new block to the blockchain when an item of the customer order is added to or removed from the vehicle, wherein the new block contains the order ID of the customer order, the customer name, the items in the customer order, the delivery address of the customer order, and the delivery date of the customer order; and
a lock configured to:
be attached to and secure the container;
store a copy of the blockchain locally in memory of the lock; and
communicate with the delivery vehicle,
wherein:
the vehicle carrying the container is further configured to communicate with the lock to determine that the container has been loaded, unloaded or is still on the vehicle.

2. The system of claim 1, further comprising a scanning device configured to:
record an item entering or leaving the container; and
transfer the recorded information of the item to the container, and

[symbol]

3. The system of claim 1, wherein the container is a tote.

4. The system of claim 1, wherein the vehicle is an automated guided vehicle or an autonomous unmanned vehicle.

5. The system of claim 2, wherein the scanning device is a RFID.

6. The system of claim 1, wherein the recorded information further comprises information of the customer order and a store associate who fills the order

7. The system of claim 1, wherein the lock is further configured to have a solar panel attached to maintain battery charge when light is available.

8. The system of claim 1, wherein the lock is further configured to communicate using WIFI or Bluetooth with the vehicle.

9. The system of claim 1, further comprising:
a camera configured to record a video of the store associate filling the container.

10. The system of claim 1, further comprising:
a mobile device configured to record a video for order filling the container.

11. The system of claim 1, further comprising:
a video recording device configured to, when the container is delivered and handed over to the customer, record the container, the lock, container contents and a customer receiving all of the above.

12. A method comprising:
assigning a customer order to a tote and a smart lock;
recording an order ID of the customer order and item information as each item of the customer order is scanned into the tote, wherein the item information includes a name of the item, a quantity of the item, a delivering date of the item, and a delivery address of the item;
recording a video as each item of the customer order is scanned into the tote;
communicating information of the order ID, the item, and the video to the smart lock;
closing and locking with the smart lock the tote when the tote is full or the order is fulfilled;
interrogating each tote to ensure that all of the totes for the customer order are loaded onto a delivery vehicle when the tote is loaded into the delivery vehicle;
directing the driver which totes should be removed at each delivery point; and
providing a key to the driver to unlock the smart lock.

13. The method of claim 12, further comprising sending an alert to the driver if a container listed on the manifest has not been loaded.

14. The method of claim 12, further comprising alerting the driver if the driver attempts to leave the delivery point with an undelivered tote.

15. The method of claim 12, further comprising recording a video of the items removed from the tote.

16. The method of claim 12, where the vehicle is an automated guided vehicle or an autonomous unmanned vehicle.

17. A non-transitory computer-readable storage medium having instructions stored which, when executed by a computing device, cause the computing device to perform operations comprising:
assigning a customer order to a tote and a smart lock;
recording an order ID of the customer order and item information as each item of the customer order is scanned into the tote, wherein the item information includes a name of the item, a quantity of the item, a delivering date of the item, and a delivery address of the item;
recording a video as each item of the customer order is scanned into the tote;
communicating information of the order ID, the item, and the video to the smart lock;
closing and locking with the smart lock the tote when the tote is full or the order is fulfilled;
interrogating each tote to ensure that all of the totes for the customer order are loaded onto a delivery vehicle when the tote is loaded into the delivery vehicle;
directing the driver which totes should be removed at each delivery point; and
providing a key to the driver to unlock the smart lock.

18. The computer-readable storage medium of claim 17, wherein the instructions further cause the computer to perform sending an alert to the driver if a container listed on the manifest has not been loaded.

19. The computer-readable storage medium of claim 17, wherein the instructions further cause the computer to perform alerting the driver if the driver attempts to leave the delivery point with an undelivered tote.

20. The computer-readable storage medium of claim 17, wherein the instructions further cause the computer to perform recording a video of the items removed from the tote.
